(19) United States
(12) Patent Application Publication
(10) Pub. No.: US 2010/0295775 A1
(43) Pub. Date: Nov. 25, 2010

(54) INPUT SYSTEM AND METHOD FOR ELECTRONIC DEVICE

(75) Inventor: JUN LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/783,562

(22) Filed: May 20, 2010

(30) Foreign Application Priority Data
May 22, 2009 (CN) 200910302539.1

(51) Int. Cl. G09G 5/00; G06F 13/24; G06F 3/041

(52) U.S. Cl. 345/156; 710/260; 345/173

(57) ABSTRACT

An input system and method for enhancing an input interface of an electronic device includes a stylus with a signal transmitting module that sends an interrupt signal to an interrupt module of the electronic device when triggered. The interrupt module identifies the interrupt signal and relays the interrupt signal accordingly in order to perform operations of the electronic device.

### BACKGROUND

1. Technical Field

Embodiments of the present disclosure relate to user interfaces, and more particularly to electronic devices and a method for inputting data.

2. Description of Related Art

Touch panels can accept multiple input means, such as handwriting input and gestures. Unfortunately, pattern recognition of such input can be difficult, overly tasking the input interface. Thus, what is called for is a system and method of data input addressing the limitations described.

### BRIEF DESCRIPTION OF THE DRAWINGS

FIG. 1 is a block diagram of one embodiment of an input system as disclosed.

FIG. 2 is a flowchart of one embodiment of an input method for an electronic device as disclosed.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented either as software and/or hardware module and may be stored in any type of computer-readable medium or other computer storage device.

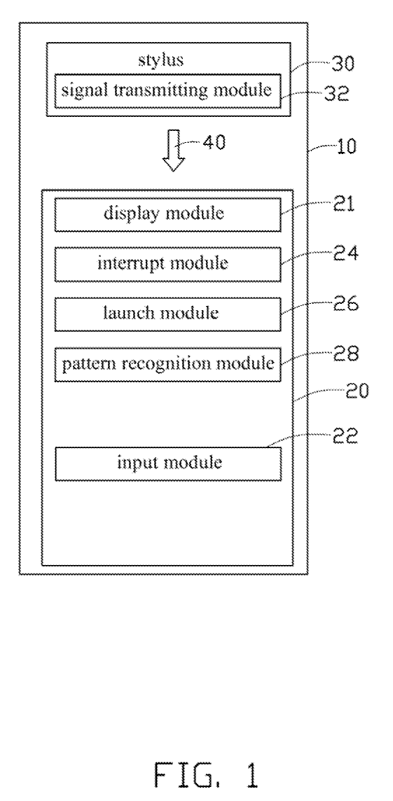

FIG. 1 is a block diagram of one embodiment of a data input system 10. The system 10 includes an electronic device 20 and a stylus 30 including a signal transmitting module 32. The electronic device 20 includes a display module 21, an input module 22, an interrupt module 24, a launch module 26, and a pattern recognition module 28. The display module 21 can be a touch panel to receive input via the stylus 30. The display module 21 relays the input to the input module 22. In one embodiment, the electronic device 20 can be a smart phone. In other embodiments, the electronic device 20 can be a personal digital assistant (PDA), handheld computer, or other applicable device.

The input module 22 includes at least two user interfaces that can be displayed on the display module 21. In one embodiment, the user interfaces include a virtual keypad and a writing pad. The virtual keypad can be displayed on the display module 21 and is operable to convert alphanumeric input to commands. The writing pad is operable to record stylus input on the display module 21 and convert the recorded input as input signals. The input signals are sent to the pattern recognition module 28.

The signal transmitting module 32 may couple with light sensors and thermal sensors triggered by, for example, movement of a finger on the stylus 30. When the sensors are triggered, the signal transmitting module 32 sends an interrupt signal to the interrupt module 24. The interrupt signal may be a terminate command, a switch command, a launch command, or a delete command.

As an example, if the light and thermal sensors are triggered by a finger moving rearward on the stylus 30, the signal transmitting module 32 sends a terminate command to the interrupt module 24. The terminate command is used to terminate an on-going procedure of the electronic device 20. In addition, for example, if the light and thermal sensors are triggered by the finger moving forward (manipulation of the stylus 30) on the stylus 30, the signal transmitting module 32 sends the switch command to the interrupt module 24.

In other embodiments, pressure sensors and motion sensors may be deployed, singularly or in combination, triggered in a number of ways. For example, the pressure sensors may be triggered by squeezing the stylus 30 with two fingers, whereas the motion sensors may be triggered by movement of the stylus 30. In the embodiment, when the pressure sensors are triggered, the signal transmitting module 32 sends the launch command to the interrupt module 24. When the motion sensors are triggered, the signal transmitting module 32 sends the delete command to the interrupt module 24.

The interrupt module 24 is operable to identify the interrupt signal 40 upon receiving the interrupt signal 40. The interrupt module 24 then relays the interrupt signal 40 to different functions of the electronic device 20.

If the interrupt signal 40 is a delete command, the interrupt module 24 relays the delete command to the display module 21. The display module 21 deletes a predetermined section from the display module 21 upon receiving the delete command. The predetermined section may be defined on the display module 21 by the stylus 30.

If the interrupt signal 40 is a switch command, the interrupt module 24 relays the switch command to the input module 22. The input module 22 switches the user interfaces for receiving the input signals upon receiving the switch command. For example, the user interface may switch from the virtual keypad to the writing pad, or vice versa.

If the interrupt signal is a terminate command, the interrupt module 24 relays the terminate command to the pattern recognition module 28. The pattern recognition module 28 terminates a recognition procedure of the data input system 10 upon receiving the terminate command.

If the interrupt signal 40 is a launch command, the interrupt module 24 relays the launch command to the launch module 26. The launch module 26 launches a new user-defined application on the electronic device 20, such as an instant messaging application, email client, or a web browser.

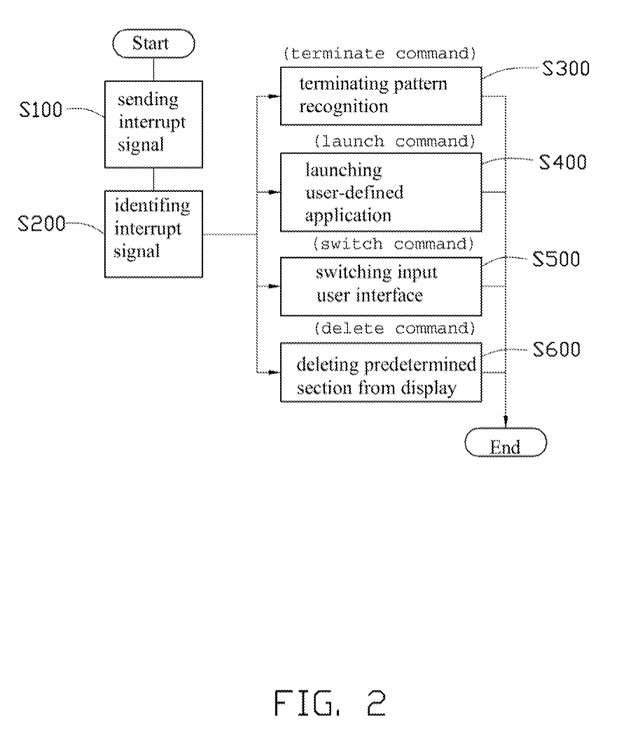

FIG. 2 is a flowchart of one embodiment of an input method for an electronic device 20. Additional blocks may be added to the method, others removed, and the ordering of the blocks may be changed.

In block S100, when the sensors installed on the stylus 30 are triggered, the signal transmitting module 32 sends the interrupt signal 40 to the interrupt module 24. The sensors may be triggered in a variety of predefined ways as described, and the interrupt signal is transmitted accordingly. For example, the interrupt signal may be the terminate command, the switch command, the launch command or the delete command.

In block S200, the interrupt module 24 relays the interrupt signal 40 accordingly after it is received and identified. If the interrupt signal 40 is the terminate command, the interrupt module 24 relays the terminate command to the pattern recognition module 28, and block S300 is implemented. If the interrupt signal 40 is the launch command, the interrupt module 24 relays the launch command to the launch module 26, and block S400 is implemented. If the interrupt signal 40 is the switch command, the interrupt module 24 relays the switch command to the input module 22, and block S500 is implemented. If the interrupt signal 40 is the delete command, the interrupt module 24 relays the delete command to the display module 21, and block S600 is implemented.

In block S300, the pattern recognition module 28 terminates the recognition procedure upon receiving the terminate command. In block S400, the launch module 26 launches a new user-defined application on the electronic device 20 upon receiving the launch command. In block S500, the input module 22 switches the user interfaces for receiving the input signals upon receiving the switch command. In block S600, the display module 21 deletes the predetermined section from the display module 21 upon receiving the delete command.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An input system for an electronic device, the system comprising:
a signal transmitting module to send an interrupt signal to the electronic device;
a display module implemented by a touch panel of the electronic device;
an input module coupled with the touch panel;
a launch module to launch a new process of an user-defined application of the electronic device;
an interrupt module to receive the interrupt signal from the signal transmitting module and relay the interrupt signal accordingly; and
a pattern recognition module to recognize input signals from the input module and terminate a recognition procedure of the input system if the interrupt signal received from the interrupt module is a terminate command.

2. The system as claimed in claim 1, wherein the input module comprises at least two user interfaces.

3. The system as claimed in claim 2, wherein the at least two user interfaces comprises a virtual keypad and a writing pad, the input module switches the at least two user interfaces from the virtual keypad to the writing pad or from the writing pad to the virtual keypad if the interrupt signal received from the interrupt module is a switch command.

4. The system as claimed in claim 1, wherein the launch module launches a new user-defined application if the interrupt signal received from the interrupt module is a launch command.

5. The system as claimed in claim 1, wherein the display module deletes a predetermined section from the display module if the interrupt signal received from the interrupt module is a delete command

6. An input method for an electronic device, the method comprising:
sending an interrupt signal to the electronic device via manipulation of a stylus on a display of the electronic device;
identifying the interrupt signal;
relaying the interrupt signal accordingly; and
terminating a pattern recognition procedure upon receiving the interrupt signal if the interrupt signal is a terminate command.

7. The method as claimed in claim 6, wherein the electronic device comprises an input module comprising a virtual keypad and a writing pad.

8. The method as claimed in claim 6, wherein if the interrupt signal is a switch command, alternating the input module upon receiving the switch command.

9. The method as claimed in claim 6, wherein if the interrupt signal is a launch command, initiating a new user-defined application upon receiving the launch command.

10. The method as claimed in claim 6, wherein if the interrupt signal is a delete command, deleting a predetermined section from a display module upon receiving the delete command.
